(19) United States
(12) Patent Application Publication
(10) Pub. No.: US 2019/0101701 A1
(43) Pub. Date: Apr. 4, 2019

(54) OPTICAL CONNECTOR FERRULE, OPTICAL CONNECTOR, AND OPTICAL COUPLING STRUCTURE

(71) Applicant: SUMITOMO ELECTRIC INDUSTRIES, LTD., Osaka-shi, Osaka (JP)

(72) Inventors: Sho YAKABE, Yokohama-shi, Kanagawa (JP); Osamu SHIMAKAWA, Yokohama-shi, Kanagawa (JP); Tomomi SANO, Yokohama-shi, Kanagawa (JP); Takako HOSOKAWA, Yokohama-shi, Kanagawa (JP); Takuro WATANABE, Yokohama-shi, Kanagawa (JP)

(73) Assignee: SUMITOMO ELECTRIC INDUSTRIES, LTD., Osaka-shi, Osaka (JP)

(21) Appl. No.: 16/086,830

(22) PCT Filed: Mar. 9, 2017
(86) PCT No.: PCT/JP2017/009582

§ 371 Date: Sep. 20, 2018

(30) Foreign Application Priority Data
Mar. 24, 2016 (JP) 2016-060492

(51) Int. Cl. G02B 6/36; G02B 6/38

(52) U.S. Cl. CPC G02B 6/3644; G02B 6/381

(57) ABSTRACT

An optical connector ferrule, an optical connector, and an optical coupling structure according to an embodiment includes an optical connector ferrule that includes a ferrule end face that faces a counterpart connector; and an optical fiber holding hole that is open to the ferrule end face and holds an optical fiber inserted thereinto. A normal direction of the ferrule end face is inclined with respect to a direction of an optical axis of the optical fiber in a section along the optical axis of the optical fiber inserted into and held in the optical fiber holding hole. An inclined angle (θ) of the normal direction with respect to the direction of the optical axis is between 10⁰ and 20°.

Priority is claimed on Japanese Patent Application No. 2016-060492, filed on Mar. 24, 2016, the entire content of which is incorporated herein by reference.

### TECHNICAL FIELD

An aspect of the present invention relates to an optical connector ferrule, an optical connector, and an optical coupling structure.

### BACKGROUND ART

A ferrule used for an optical connector for connecting multiple optical fibers is disclosed in Non-Patent Literature 1. This ferrule has a plurality of holes for holding a plurality of optical fibers, and guide holes into which positioning guide pins are inserted. As the guide pins are inserted into the guide holes, accurate positioning of the ferrule is made.

### CITATION LIST

### Non-Patent Literature

[Non-Patent Literature 1] S. Nagasawa et al., “A high-performance single-mode multifiber connector using oblique and direct endface contact between multiple fibers arranged in a plastic ferrule,” IEEE Photonics Technology Letters, vol. 3, no. 10, pp. 937-939 (1991)

### SUMMARY OF INVENTION

An optical connector ferrule according to an embodiment of the present disclosure includes a ferrule end face that faces a counterpart connector, and an optical fiber holding hole that is open to the ferrule end face and holds an optical fiber inserted thereinto. A normal direction of the ferrule end face is inclined with respect to a direction of a central axis of the optical fiber holding hole, and an inclined angle of the normal direction with respect to the direction of the central axis is between 10° and 20°.

An optical connector according to an embodiment of the present disclosure includes the aforementioned optical connector ferrule, and an optical fiber that is inserted into an optical fiber holding hole and has a tip face exposed to the ferrule end face. A normal direction of the tip face of the optical fiber is inclined with respect to a direction of an optical axis of the optical fiber. An inclined angle of the normal direction of the tip face with respect to the direction of the optical axis is between 10° and 20°.

An optical coupling structure according to an embodiment of the present disclosure includes first and second optical connectors connected to each other. Each of the first and second optical connectors includes an optical fiber, and an optical connector ferrule that has a ferrule end face and holds the optical fiber. The ferrule end face of the first optical connector and the ferrule end face of the second optical connector face each other. A tip face of the optical fiber is exposed to the ferrule end face in each of the first and second optical connectors. A normal direction of the tip face of the optical fiber and a normal direction of the ferrule end face are both inclined with respect to a direction of an optical axis of the optical fiber in a section along the optical axis of the optical fiber, and an inclined angle of the normal direction of the ferrule end face with respect to the direction of the optical axis and an inclined angle of the normal direction of the tip face of the optical fiber with respect to the direction of the optical axis are both between 10° and 20°. The optical coupling structure further includes a spacer configured to regulate an interval between the ferrule end face of the first optical connector and the ferrule end face of the second optical connector, and a guide pin configured to fix a relative position between the first optical connector and the second optical connector.

### BRIEF DESCRIPTION OF DRAWINGS

FIG. 1 is a side sectional view illustrating a configuration of an optical connector ferrule according to an embodiment of the present disclosure.

FIG. 2 is a front view of the optical connector ferrule when is viewed from a connecting direction.

FIG. 3 is a side sectional view illustrating an optical connector having the optical connector ferrule according to an embodiment, and an optical coupling structure made up of a counterpart connector.

FIG. 4 is an enlarged sectional view illustrating a part D illustrated in FIG. 3.

FIG. 5 is a view schematically illustrating multiple reflection of light which occurs between two tip faces.

FIG. 6 is a graph illustrating a relation between a distance between the two tip faces and a coupling loss of light.

FIG. 7 is a graph illustrating a relation between the distance between the two tip faces and a fluctuation range of a coupling intensity of light.

FIG. 8 is a graph illustrating a relation between an inclined angle of the tip face and the distance between the two tip faces when the fluctuation range of the coupling intensity of light is made constant.

FIG. 9A is a view schematically illustrating a conventional optical coupling structure.

FIG. 9B is a view schematically illustrating the conventional optical coupling structure.

### DESCRIPTION OF EMBODIMENT

### Problems to be Solved by the Present Disclosure

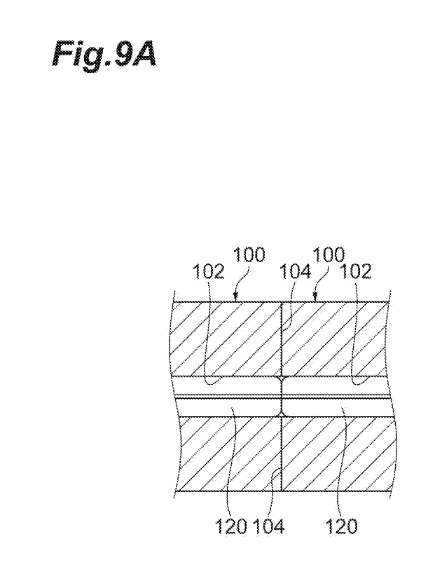

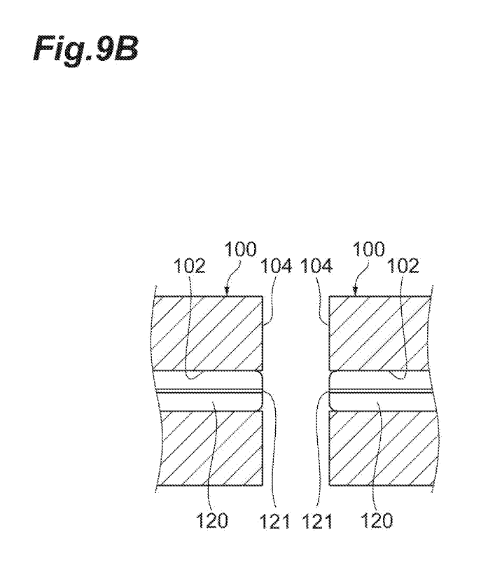

A physical contact (PC) method is generally known as a method for connector connection between optical fibers. FIG. 9A is a side sectional view illustrating an example of a structure of a ferrule in a PC method. A ferrule 100 has a columnar appearance, and has a hole 102 for holding an optical fiber 120 on a central axis. The optical fiber 120 is inserted into the hole 102. In this PC method, a tip face of the optical fiber 120 is physically brought into contact with and pressed against a tip face of an optical fiber of a counterpart connector, and thereby the optical fibers 120 are optically coupled. This method is used when single-core optical fibers are mainly connected.

However, the aforementioned method has the following problems. When the connection is performed in a state in which foreign materials adhere to a ferrule end face 104, the foreign materials adhere closely to the ferrule end face 104 due to a pressing force. There is a need to use a contact type cleaner in order to clean off the closely adhered foreign materials. In addition, there is a need to frequently perform cleaning in order to prevent close adhesion of foreign materials. In the case of a multifiber ferrule for simultaneously connecting a plurality of optical fibers 120, a predetermined pressing force is required for each optical fiber 120. Thus, as the number of optical fibers 120 increases, a great force is required for the connection.

With respect to the aforementioned problems, as illustrated in, for example, FIG. 9B, a structure in which an interval is set between the tip faces 121 of the two optical fibers 120 connected to each other may be conceived. However, in the structure in which an interval is set between the tip faces 121, reflection of light occurs at the ferrule end faces 104, and multiple reflection in which this reflection is repeated between the two ferrule end faces 104 several times occurs. Due to this multiple reflection, a plurality of rays whose phases are different from each other are incident upon the optical fibers 120. In this case, a problem that an intensity of the light coupled to the optical fibers 120 varies occurs.

The present disclosure was made in view of this problem, and is directed to providing an optical connector ferrule, an optical connector, and an optical coupling structure, capable of inhibiting the occurrence of multiple reflection.

### Advantageous Effects of the Invention

According to the present disclosure, the occurrence of multiple reflection can be inhibited.

### Description of Embodiments

First, details of an embodiment of the present disclosure will be listed and described. An optical connector ferrule according to an embodiment of the present disclosure includes a fen⁻ule end face that faces a counterpart connector, and an optical fiber holding hole that is open to the ferrule end face and holds an optical fiber inserted thereinto. A normal direction of the ferrule end face is inclined with respect to a direction of a central axis of the optical fiber holding hole. An inclined angle of the normal direction with respect to the direction of the central axis is between 10° and 20°.

An optical connector according to an embodiment of the present disclosure includes the aforementioned optical connector ferrule, and an optical fiber that is inserted into an optical fiber holding hole and has a tip face exposed to the ferrule end face. A not real direction of the tip face of the optical fiber is inclined with respect to a direction of an optical axis of the optical fiber. An inclined angle of the normal direction of the tip face with respect to the direction of the optical axis is between 10° and 20°.

An optical coupling structure according to an embodiment of the present disclosure includes first and second optical connectors connected to each other. Each of the first and second optical connectors includes an optical fiber, and an optical connector ferrule that has a ferrule end face and holds the optical fiber. The ferrule end face of the first optical connector and the ferrule end face of the second optical connector face each other. A tip face of the optical fiber is exposed to the ferrule end face in each of the first and second optical connectors. A nontrial direction of the tip face of the optical fiber and a normal direction of the ferrule end face are inclined with respect to a direction of an optical axis of the optical fiber in a section along the optical axis of the optical fiber together, and an inclined angle of the normal direction of the ferrule end face with respect to the direction of the optical axis and an inclined angle of the normal direction of the tip face of the optical fiber with respect to the direction of the optical axis are between 10° and 20° together. The optical coupling structure further includes a spacer configured to regulate an interval between the ferrule end face of the first optical connector and the ferrule end face of the second optical connector, and guide pins configured to fix a relative position between the first optical connector and the second optical connector.

In the optical connector ferrule, the optical connector, and the optical coupling structure that are described above, the normal direction of the ferrule end face is inclined with respect to the direction of the central axis of the optical fiber holding hole, and the inclined angle of the normal direction of the ferrule end face with respect to the direction of the central axis of the optical fiber holding hole is between 10° and 20°. In this way, the inclined angle of the normal direction with respect to the direction of the central axis is set to 10° or more, and thereby return light directed from the ferrule end face to the counterpart connector can be kept far apart from the optical axis of the optical fiber. Accordingly, the return light can be kept far apart from the optical axis of the optical fiber, and thereby it can be made difficult for the return light to be incident upon the optical fiber of the counterpart connector. Accordingly, multiple reflection of light between the two ferrule end faces can be suppressed. Further, the inclined angle of the normal direction with respect to the direction of the central axis of the optical fiber holding hole is set to 20° or less, and thereby a difference in coupling intensity between a plurality of polarization components of light can be reduced.

The aforementioned optical connector ferrule may have a plurality of optical fiber holding holes. According to the optical connector ferrule, a great force is made unnecessary for connection, and a plurality of optical fibers can be connected at one time.

In the aforementioned optical coupling structure, the position of the optical fiber of the first optical connector and the position of the second optical fiber may deviate from each other in the section along the optical axis in a direction that intersects the optical axis. In the optical coupling structure, since the normal direction of the tip face of the optical fiber is inclined with respect to the direction of the optical axis of the optical fiber, an optical path that extends from the tip face of the optical fiber leans to the direction that intersects the optical axis of the optical fiber due to refraction on the tip face. Even with this configuration, the position of the optical fiber of the first optical connector and the position of the optical fiber of the second optical connector deviate from each other in the direction that intersects the optical axis, and thereby the optical fiber of the first optical connector and the optical fiber of the second optical connector can be suitably optically coupled.

A thickness of a spacer may be between 5 μm and 30 μm. As described above, the inclined angle of the normal direction of the ferrule end face with respect to the direction of the optical axis of the optical fiber and the inclined angle of the normal direction of the tip face of the optical fiber with respect to the direction of the optical axis are between 10° and 20° together. In this case, the thickness of the spacer may be between 5 μm and 30 μm, and thereby the optical coupling structure in which multiple reflection of the light is suppressed is realized. Further, in this way, an interval between the tip faces of the two optical fibers is defined by the thin spacer, and thereby the distance between the two tip faces is shortened, and these optical fibers can be connected with a low coupling loss despite having a configuration without a lens being interposed therebetween.

### Details of Embodiments

Hereinafter, specific examples of the optical connector ferrule, the optical connector, and the optical coupling structure according to the embodiments of the present disclosure will be described with reference to the drawings. The present invention is not limited to these examples, and the scope of the present invention is defined by the claims, and is intended to include all modifications and alternations within the meanings and range equivalent to the claims. In the following description, in the description of the drawings, the same reference signs are given to identical or equivalent elements, and duplicate description thereof will be omitted.

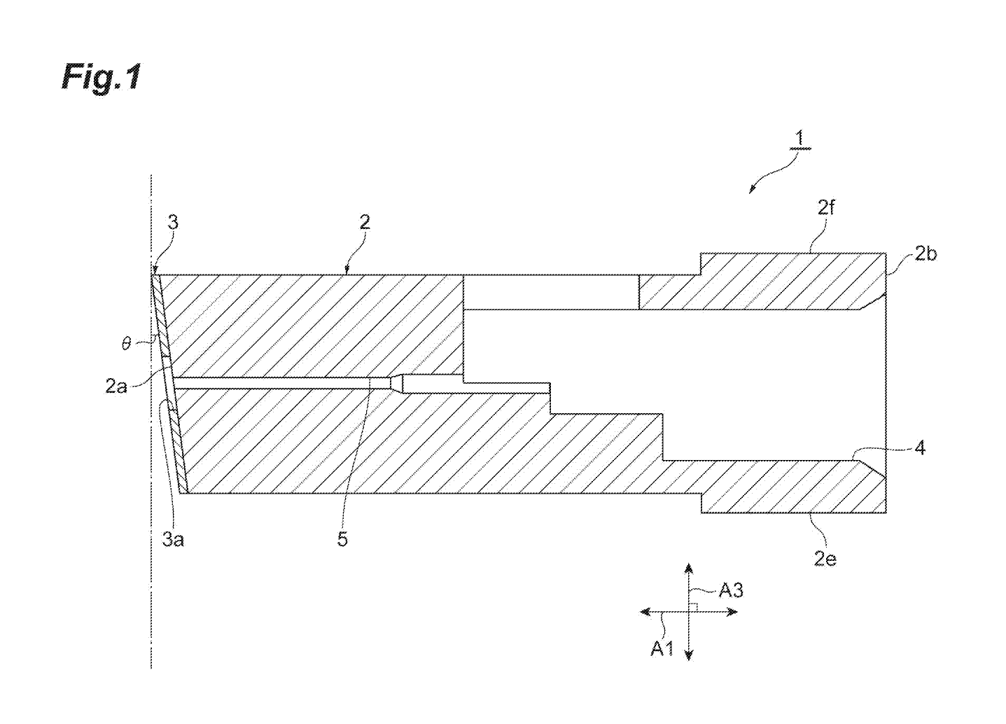

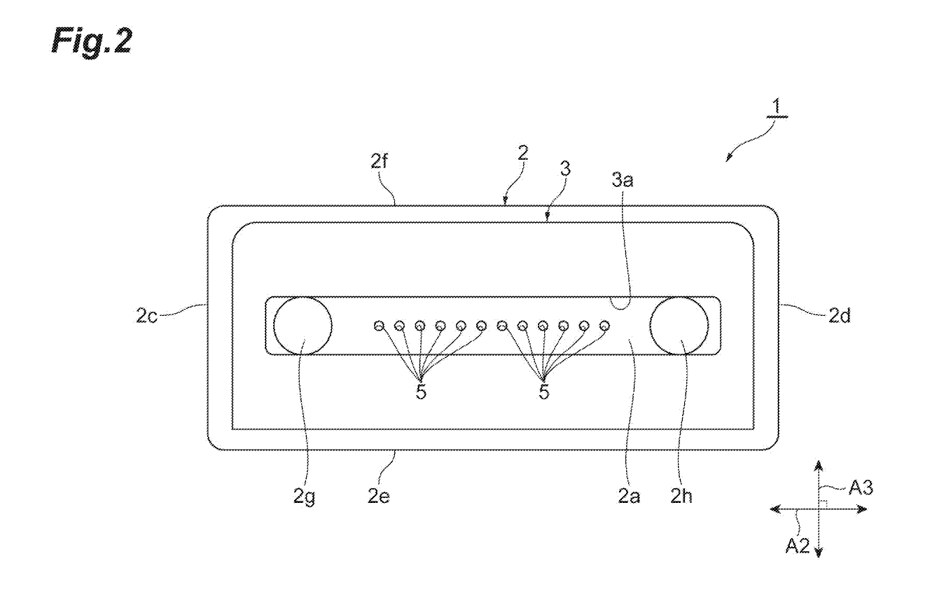

FIG. 1 is a side sectional view illustrating a configuration of an optical connector ferrule 1 according to an embodiment of the present disclosure, and illustrates a section in a connecting direction A1 (i.e., in a direction of the optical axis of an optical fiber). FIG. 2 is a front view of the optical connector ferrule 1 viewed from the connecting direction A1.

The optical connector ferrule 1 includes a main body 2 and a spacer 3. The main body 2 has an approximately rectangular parallelepiped shape in external appearance, and is formed of, for instance, a resin. The main body 2 has a flat ferrule end face 2a that is provided on one end side in the connecting direction A1 and faces a counterpart connector, and a rear end face 2b that is provided on the other end side. In addition, the main body 2 has a pair of lateral surfaces 2c and 2d, a bottom surface 2e, and a top surface 2f that extend in the connecting direction A1. An introduction hole 4 for receiving a plurality of optical fibers in a bundle is formed in the rear end face 2b. For example, the plurality of optical fibers are introduced in a form of 0.25 mm coated fibers, and 0.9 mm jacketed fibers or a tape fiber.

The main body 2 further includes a plurality of optical fiber holding holes 5. Each optical fiber holding hole 5 holds an inserted optical fiber. The plurality of optical fiber holding holes 5 are penetrated from the introduction hole 4 to the ferrule end face 2a. A front end of each optical fiber holding hole 5 is open on the ferrule end face 2a. Each optical fiber holding hole 5 extends in the connecting direction A1, and a direction of the central axis thereof is identical to the connecting direction A1. Openings of the plurality of optical fiber holding holes 5 are arranged on the ferrule end face 2a in a direction A2 intersecting the connecting direction A1 in a row. The direction A2 is orthogonal to, for instance, the connecting direction A1.

The optical connector ferrule 1 further includes a pair of guide pins 2g and 2h. The guide pins 2g and 2h protrude from the ferrule end face 2a in the connecting direction A1. The guide pins 2g and 2h are inserted into guide holes of an optical connector ferrule of the counterpart connector connected to the optical connector ferrule 1. The guide pins 2g and 2h are fixed at a relative position between the optical connector ferrule 1 and the optical connector ferrule of the counterpart connector. The pair of guide pins 2g and 2h are arranged in the direction A2, and are provided at positions between which the plurality of optical fiber holding holes 5 are sandwiched (in other words, opposite ends of the row of the optical fiber holding holes 5).

The spacer 3 is a film shaped (thin film shaped) member, and a part thereof is at least disposed on the ferrule end face 2a and is sandwiched between the ferrule end face 2a and a ferrule end face of the counterpart connector, thereby regulating an interval between the ferrule end face 2a and the ferrule end face of the counterpart connector. A material of the spacer 3 is not particularly limited, and various materials may be used as the material of the spacer 3. The spacer 3 is preferably formed of a resin (e.g., polyphenylene sulfide (PPS)) or a metal. At least part of the spacer 3 is joined to any part of the main body 2. The joining of the spacer 3 and the main body 2 is performed by, for instance, adhesion through an adhesive or welding (laser welding or the like).

For example, when the material of the spacer 3 and the material of the main body 2 are different from each other (e.g., in the case of a metal and a resin), the junction of the spacer 3 to the main body 2 is performed by an adhesive. Meanwhile, when the material of the spacer 3 and the material of the main body 2 are identical to each other (e.g., in the case of a resin and a resin), the junction of the spacer 3 to the main body 2 is performed by fusion. This is because, when a linear expansion coefficient of the spacer 3 and a linear expansion coefficient of the main body 2 are different from each other, there is concern that the spacer 3 may peel off from the main body 2 in the event of a change in temperature. However, when the material of the spacer 3 and the material of the main body 2 are identical to each other, reliability is increased by fusion without the above concern. In the present embodiment, the spacer 3 is provided only on the ferrule end face 2a, and the spacer 3 is joined to the ferrule end face 2a.

The spacer 3 has an opening 3a that exposes the ferrule end face 2a. The opening 3a exposes openings of the plurality of optical fiber holding holes 5 in order to allow passage of a plurality of optical paths that extend between tip faces of the plurality of optical fibers held in the plurality of optical fiber holding holes 5 and tip faces of the plurality of optical fibers of the counterpart connector. In an example, the opening 3a is formed in the direction A2 that is a longitudinal direction. For example, a length of the opening 3a in the direction A2 may be 5.31 mm, and a width of the opening 3a in a direction A3 intersecting the direction A2 may be 0.71 mm. For example, the direction A3 is orthogonal to a plane that extends in the connecting direction A1 and the direction A2.

External dimensions of the spacer 3 are identical to those of the ferrule end face 2a, or are smaller than those of the ferrule end face 2a. Thereby, peeling off of the spacer 3 caused by hooking of the spacer 3 to a circumferential edge can be prevented. A thickness of the spacer 3 is for instance between 5 μm and 30 μm. Thereby, an interval between the ferrule end face 2a and the ferrule end face of the counterpart connector is regulated to be between 5 μm and 30 μm. Inner edges of the opening 3a of the spacer 3 contact with outer circumferential surfaces of the guide pins 2g and 2h when viewed from axial directions (i.e., the connecting direction A1) of the guide pins 2g and 2h. In the present embodiment, both a pair of inner edges of the opening 3a in the direction A2 contact with the outer circumferential surfaces of the guide pins 2g and 2h.

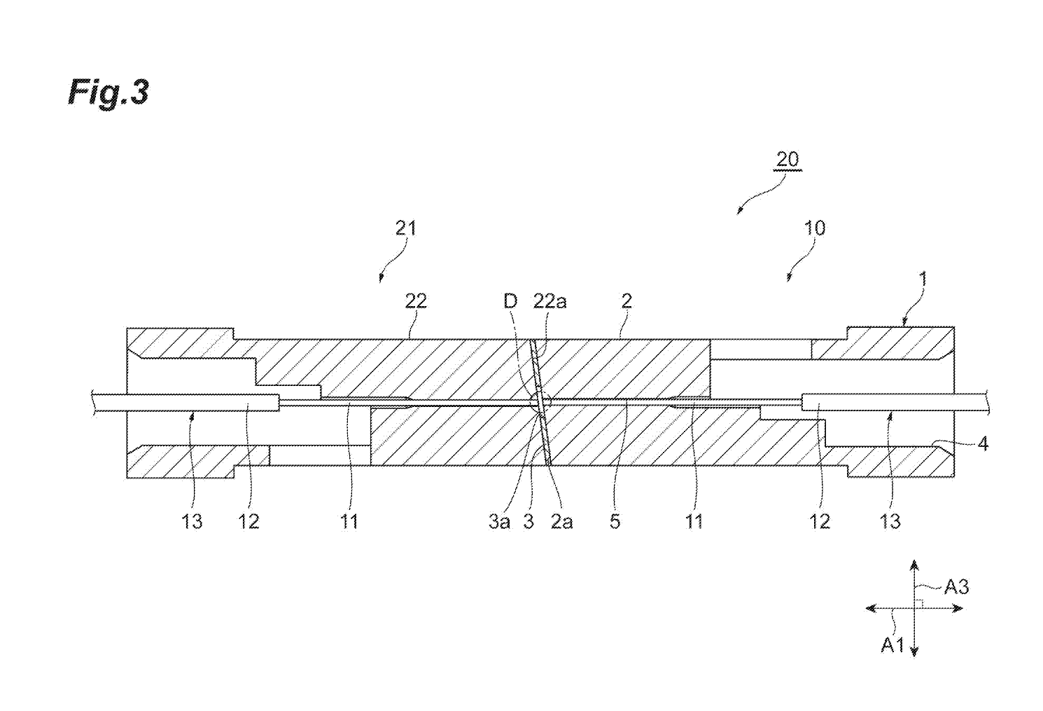

FIG. 3 is a side sectional view illustrating an optical coupling structure 20 made up of an optical connector (a first connector) 10 having the optical connector ferrule 1 of the present embodiment and a counterpart connector (a second connector) 21. The optical connector 10 further includes a plurality of optical fibers 11 in addition to the optical connector ferrule 1. The optical fibers 11 are for instance single-mode fibers. The counterpart connector 21 includes a main body 22 acting as an optical connector ferrule, and a plurality of optical fibers 11. In the optical coupling structure 20, the ferrule end face 2a of the main body 2 of the optical connector 10 and a ferrule end face 22a of the main body 22 of the counterpart connector 21 face each other.

The plurality of optical fibers 11 extend in the directions of the central axes of the optical fiber holding holes 5, that is, in the connecting direction A1. Each optical fiber 11 is coated with a resin coating 12, and constitutes a coated fiber 13. The resin coating 12 is removed from the middle thereof to a tip thereof in the connecting direction A1, and thereby each optical fiber 11 is exposed. These optical fibers 11 are inserted into and held in the plurality of optical fiber holding holes 5 of the main body 2, respectively.

As described above, the spacer 3 is sandwiched between the ferrule end face 2a of the optical connector 10 and the ferrule end face 22a of the counterpart connector 21, thereby regulating an interval between these ferrule end faces 2a and 22a. For this reason, the surface of the spacer 3 abuts the ferrule end face 22a of the counterpart connector 21. The optical fibers 11 of the optical connector 10 and the optical fibers 11 of the counterpart connector 21 are optically coupled via the opening 3a of the spacer 3.

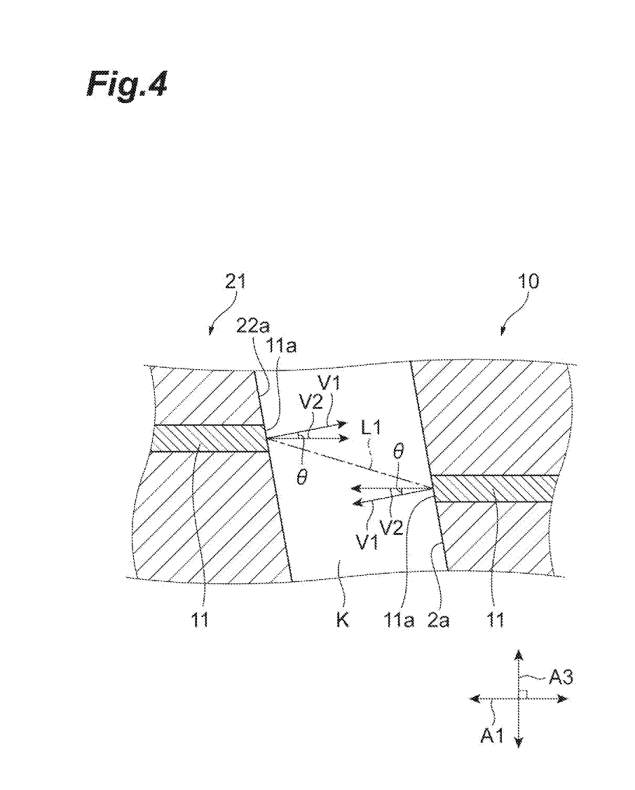

FIG. 4 is an enlarged sectional view illustrating a part D illustrated in FIG. 3. As illustrated in FIG. 4, tip faces 1 la of the optical fibers 11 are exposed on the ferrule end faces 2a and 22a, and are preferably flush with the ferrule end faces 2a and 22a. In a section along the optical axis of each optical fiber 11, a normal direction V1 of the tip face 11a of each optical fiber 11 is inclined with respect to the direction of the central axis of each optical fiber holding hole 5, that is, the direction V2 of the optical axis of each optical fiber 11. Hereinafter, the inclined angle of the normal direction V1 with respect to the direction V2 of the optical axis is set to an inclined angle θ. The inclined angle θ is identical to an inclined angle of the tip face 11a with respect to a surface perpendicular to the optical axis of each optical fiber 11.

In the present embodiment, normal directions of the ferrule end faces 2a and 22a are identical to the normal direction V1 of the tip face 11a. An optical path L1 of light emitted from the tip face 11a is refracted in a direction opposite to a direction of the inclination of the tip face 11a on the tip face 11a. Accordingly, the central axis of each optical fiber 11 of the optical connector 10 and the central axis of each optical fiber 11 of the counterpart connector 21 deviate from each other in a refracting direction.

The tip face 11a of each optical fiber 11 of the optical connector 10 and the tip face 11a of each optical fiber 11 of the counterpart connector 21 are directly optically coupled with only an interval K therebetween without an optical element such as a lens or a refractive index matching agent being interposed therebetween. The interval K is filled with, for instance, air.

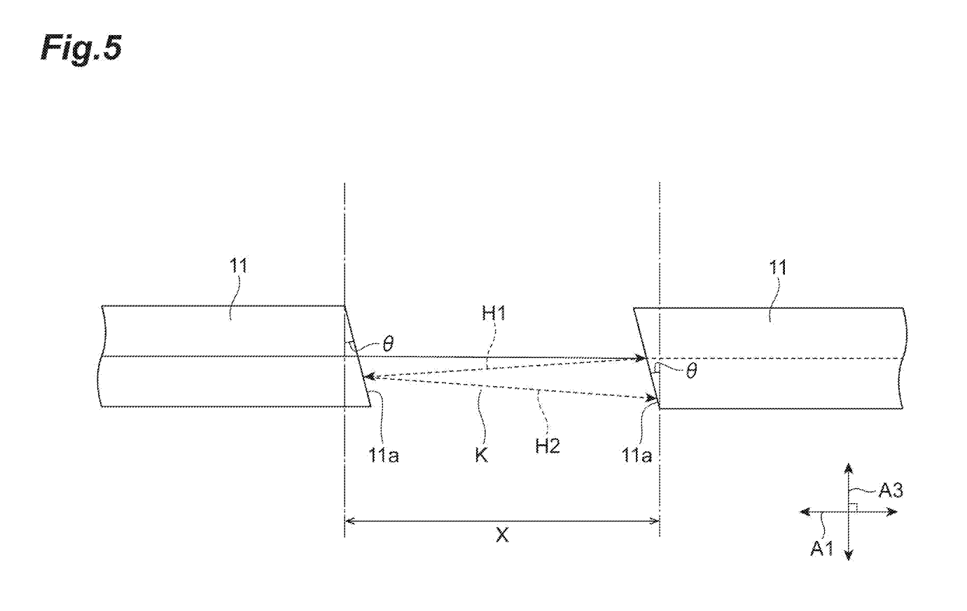

FIG. 5 is a view schematically illustrating multiple reflection of light which occurs between the tip faces 11a of the two optical fibers 11. As illustrated in FIG. 5, in a structure in which an interval K is provided between the two tip faces 11a, reflection occurs at the tip faces 11a, and multiple reflection in which this reflection is repeated between the two tip faces 11a several times occurs.

To be specific, in the optical coupling structure in which the interval K is interposed between the two tip faces 11a, multiple reflection in which the reflection is repeated between the two tip faces 11a occurs like primary light H1 that is reflected from the tip face 11a of one optical fiber 11 toward the other optical fiber 11 and secondary light H2 that is reflected from the tip face 11a of the other optical fiber 11 toward one optical fiber 11 by receiving the primary light H1 on the tip face 11a of the other optical fiber 11. Due to this multiple reflection or multiple reflection of light between the ferrule end faces 2a and 22a, a plurality of rays whose phases are different from each other may be incident upon the optical fiber 11. Therefore, a problem that an intensity of light coupled to the optical fiber 11 varies may occur.

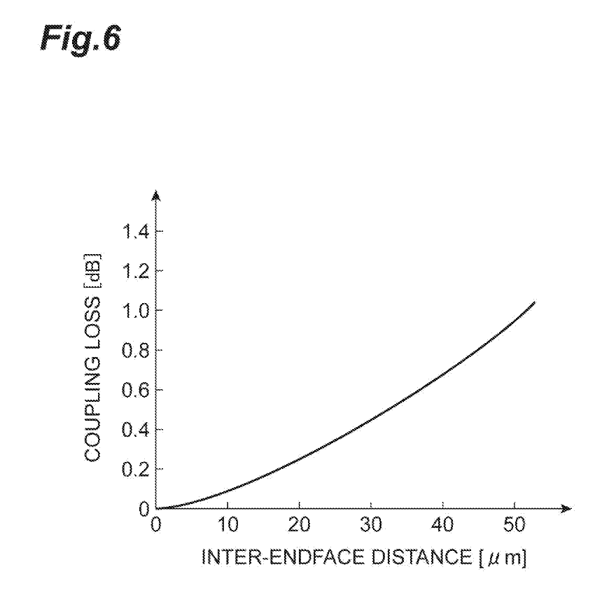

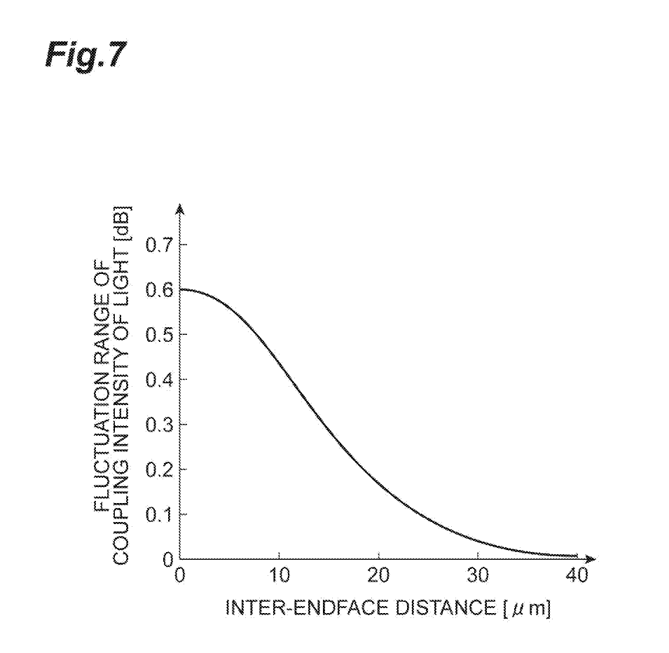

FIG. 6 is a graph illustrating a relation between an inter-endface distance X between the two tip faces 11a and a coupling loss of light coupled to the optical fiber 11 when an inclined angle θ is 8°. FIG. 7 is a graph illustrating a relation between the inter-endface distance X and a fluctuation range of coupling intensity of light coupled to the optical fiber 11 when the inclined angle θ is 8°.

As illustrated in FIG. 6, as the inter-endface distance X becomes longer, the coupling loss of light coupled to the optical fiber 11 increases. However, as illustrated in FIG. 7, as the inter-endface distance X becomes longer, the fluctuation range of the coupling intensity of light coupled to the optical fiber 11 is reduced. This is because, as the inter-endface distance X becomes longer, the primary light H1 and the secondary light H2 as illustrated in FIG. 5 greatly deviate from the optical fiber 11 in the direction A3, and a reflection frequency of light on the tip face 11a is reduced. Even when the inclined angle θ is enlarged, the primary light H1 and the secondary light H2 greatly deviate from the optical fiber 11 in the direction A3, and thus the multiple reflection can be reduced on the tip face 11a.

The fluctuation range of the coupling intensity of light coupled to the optical fiber 11 illustrated in FIG. 7 has values corresponding to the reflection frequency of light on the tip face 11a. As the reflection frequency of light becomes higher, the fluctuation range increases. The fluctuation range is preferably small. For example, if the fluctuation range can be set to 0.025 dB or less, an influence due to multiple reflection can be ignored. As illustrated in FIG. 7, when the inclined angle θ is 8°, the inter-endface distance X should be set to 30 μm or more to set the fluctuation range of the coupling intensity of light coupled to the optical fiber 11 to 0.025 dB or less.

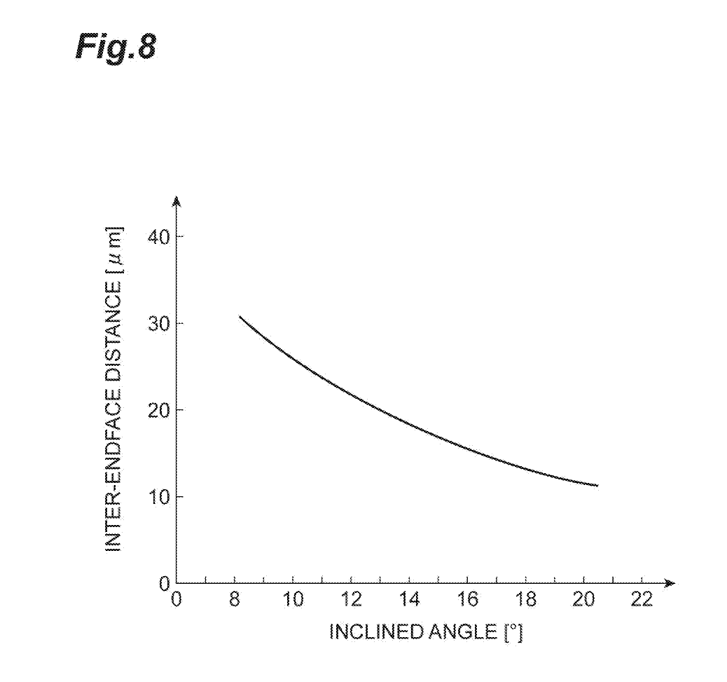

FIG. 8 is a graph illustrating a relation between the inclined angle θ and the inter-endface distance X when the fluctuation range of the coupling intensity of light coupled to the optical fiber 11 is 0.025 dB. As described above, when the inclined angle θ is 8°, the inter-endface distance X should be set to 30 μm or more to set the fluctuation range to 0.025 dB or less. However, when the inclined angle θ is greater than 8°, even if the inter-endface distance X is set to be smaller than 30 μm, the fluctuation range can be set to 0.025 dB or less. When the inter-endface distance X is reduced, the coupling loss of light coupled to the optical fiber 11 can be reduced, and thus the inclined angle θ is preferably enlarged to reduce the inter-endface distance X.

In the optical connector ferrule 1, the optical connector 10, and the optical coupling structure 20, the normal direction V1 of the ferrule end face 2a is inclined with respect to the direction V2 of the optical axis of the optical fiber 11 (the direction of the central axis of the optical fiber holding hole 5), and the inclined angle θ of the normal direction V1 of the ferrule end face 2a with respect to the direction V2 of the optical axis of the optical fiber 11 is between 10° and 20°. In this way, the inclined angle θ of the normal direction V1 with respect to the direction V2 of the optical axis is set to 10° or greater, and thereby the return light directed from the ferrule end face 2a toward the counterpart connector 21 can be greatly separated from the optical axis of the optical fiber 11. Accordingly, it is made difficult for the return light like the primary light H1 and the secondary light H2 to be incident upon the optical fiber 11 of the counterpart connector 21. Therefore, since the reflection frequency of light on the ferrule end faces 2a and 22a can be reduced, multiple reflection of light between the ferrule end faces 2a and 22a can be suppressed.

When the inclined angle θ of the normal direction V1 with respect to the direction V2 of the optical axis is greater than 20°, a problem that a difference in coupling intensity between a plurality of polarization components of light increases occurs, and a problem that light is not emitted from the tip face 11a by total reflection occurs. In contrast, in the present embodiment, since the inclined angle θ is less than or equal to 20°, the total reflection can be suppressed, and the difference in coupling intensity between the plurality of polarization components of light can be suppressed.

The optical connector ferrule 1 has the plurality of optical fiber holding holes 5. Therefore, in the optical connector ferrule 1, a great force cannot be required for connection, and the plurality of optical fibers 11 can be connected at once.

In the optical coupling structure 20, the position of the optical fiber 11 of the optical connector 10 and the position of the optical fiber 11 of the counterpart connector 21 deviate from each other in the section along the optical axis in the direction A3 intersecting the optical axis. In the optical coupling structure 20, since the normal direction V1 of the tip face 11a of the optical fiber 11 is inclined with respect to the direction V2 of the optical axis of the optical fiber 11, the optical path L1 that extends from the tip face 11a of the optical fiber 11 leans to the direction A3 intersecting the optical axis of the optical fiber 11 due to refraction on the tip face 11a. Even with this configuration, the position of the optical fiber 11 of the optical connector 10 and the position of the optical fiber 11 of the counterpart connector 21 deviate from each other in the direction A3, and thereby the optical fiber 11 of the optical connector 10 and the optical fiber 11 of the counterpart connector 21 can be suitably optically coupled.

The thickness of the spacer 3 is between 5 μm and 30 μm. As described above, the inclined angle θ of the normal direction V1 of the tip face 11a with respect to the direction V2 of the optical axis and the inclined angle θ of the normal direction V1 of each of the ferrule end faces 2a and 22a with respect to the direction V2 of the optical axis are between 10° and 20° together. In this case, since the thickness of the spacer 3 is set to 5 μm or more and 30 μm or less, the optical coupling structure 20 in which multiple reflection of light is suppressed is realized. Further, the interval between the two tip faces 11a is regulated by the thin spacer 3 in this way, and thereby the distance between the two optical fibers 11 is shortened, and the two optical fibers 11 can be optically coupled with a low coupling loss despite a configuration without interposing a lens.

The optical connector ferrule, the optical connector, and the optical coupling structure according to the present invention are not limited to the aforementioned embodiment, and various modifications are possible as well. For example, in the aforementioned embodiment, the interval K between the ferrule end faces 2a and 22a is filled with air. However, the interval K may be filled with a medium other than air as long as the medium has a constant refractive index. In the aforementioned embodiment, the example in which the normal directions of the ferrule end faces 2a and 22a are identical to the normal directions V1 of the tip faces 11a has been described, but the normal directions of the ferrule end faces may be different from the normal directions of the tip faces of the optical fibers.

Shapes and sizes of the main body, the spacer, and the guide pins of the optical connector ferrule can be appropriately changed. Further, in the aforementioned embodiment, the present invention is applied to a multifiber ferrule, but it may also be applied to a single-fiber ferrule.

### REFERENCE SIGNS LIST

1 Optical connector ferrule

2 Main body

2a, 22a Ferrule end face

2b Rear end face

2c, 2d Lateral surface

2e Bottom surface

2f Top surface

2g, 2h Guide pin

3 Spacer

3a Opening

4 Introduction hole

5 Optical fiber holding hole

10 Optical connector (first optical connector)

11 Optical fiber

11a Tip face

12 Resin coating

13 Coated fiber

20 Optical coupling structure

21 Opponent connector (second optical connector)

22 Main body

A1 Connecting direction

A2, A3 Direction.

H1 Primary light

H2 Secondary light

K Interval

L1 Optical path

V1 Normal direction

V2 Direction of optical axis

X Inter-endface distance

θ Inclined angle

1. An optical connector ferrule having a ferrule end face that faces a counterpart connector, and an optical fiber holding hole that is open to the ferrule end face and holds an optical fiber inserted thereinto,
wherein a normal direction of the ferrule end face is inclined with respect to a direction of a central axis of the optical fiber holding hole, and
an inclined angle of the normal direction with respect to the direction of the central axis is between 10° and 20°.

2. The optical connector ferrule according to claim 1,
wherein the optical fiber holding hole includes a plurality of optical fiber holding holes.

3. An optical connector comprising:
the optical connector ferrule according to claim 1; and
an optical fiber inserted into the optical fiber holding hole and having a tip face exposed to the ferrule end face,
wherein a normal direction of the tip face of the optical fiber is inclined with respect to a direction of an optical axis of the optical fiber, and
an inclined angle of the normal direction of the tip face with respect to the direction of the optical axis is between 10° and 20°.

4. An optical coupling structure comprising
first and second optical connectors connected to each other,
wherein each of the first and second optical connectors includes an optical fiber, and an optical connector ferrule that has a ferrule end face and holds the optical fiber,
the ferrule end face of the first optical connector and the ferrule end face of the second optical connector face each other,
a tip face of the optical fiber is exposed to the ferrule end face in each of the first and second optical connectors,
a normal direction of the tip face of the optical fiber and a normal direction of the ferrule end face are both inclined with respect to a direction of an optical axis of the optical fiber in a section along the optical axis of the optical fiber, and
an inclined angle of the normal direction of the ferrule end face with respect to the direction of the optical axis and an inclined angle of the normal direction of the tip face of the optical fiber with respect to the direction of the optical axis are both between 10° and 20°, and
the optical coupling structure further comprising
a spacer configured to regulate an interval between the ferrule end face of the first optical connector and the ferrule end face of the second optical connector, and
guide pins configured to fix a relative position between the first optical connector and the second optical connector.

5. The optical coupling structure according to claim 4,
wherein a position of the optical fiber of the first optical connector and a position of the optical fiber of the second optical connector deviate from each other in the section in a direction that intersects the optical axis.

6. The optical coupling structure according to claim 4,
wherein a thickness of the spacer is between 5 μm and 30 μm.
